(19) United States
(12) Patent Application Publication
(10) Pub. No.: US 2008/0259647 A1
(43) Pub. Date: Oct. 23, 2008

(54) Power Converter

(75) Inventor: Pieter Martin Risseeuw, Brugge (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/091,101

(22) PCT Filed: Oct. 24, 2006
(86) PCT No.: PCT/IB06/53898

§ 371 Date: Apr. 22, 2008

(30) Foreign Application Priority Data
Oct. 25, 2005 (EP) 05109952.1

(51) Int. Cl. H02M 3/335

(52) U.S. Cl. 363/21.1

(57) ABSTRACT

A power converter comprises a series arrangement of a first main current path of a first controllable switch (M2) and a second main current path of a second controllable switch (M3). The series arrangement is arranged to receive a DC-input voltage (V1). A series arrangement of an inductance (L) and a capacitance (2) is arranged in parallel with the second main current path. An output node (NO) which is coupled to the inductance (L) supplies an output voltage (VO) of the power converter. The power converter further comprises a means (M1) for varying the capacitance (2). A controller (1) controls the first controllable switch (M2) and the second controllable switch (M3) with a variable repetition frequency (fr) to stabilize the output voltage (VO), and controls the means (M1) for varying to vary the capacitance (2) or the inductance (L) in dependence on an output power of the power converter.

### FIELD OF THE INVENTION

The invention relates to a power converter, to an apparatus having different power modes and comprising the power converter, and a method of controlling the power converter.

### BACKGROUND OF THE INVENTION

Usually, a resonant LLC power converter comprises a series arrangement of two MOSFETs across which series arrangement a DC-input voltage is supplied. The LLC power converter further comprises a series arrangement of a primary winding of a transformer and a capacitor, which series arrangement is arranged in parallel with one of the MOSFETS. The transformer has a secondary winding which supplies a DC-voltage to a load via a rectifier. A controller controls the first and the second controllable switch with a variable repetition frequency to stabilize the output voltage across the load.

Such an LLC power converter is for example disclosed, starting on page EN93, in the Philips Electronics Service Manual of Chassis FM24AA, published in 2002 and having number EN 3122 785 12770.

The peak power level which such an LLC power converter is able supply to the load is determined by both the inductance value of the inductance formed by the transformer and the capacitance of the capacitor. One possibility to increase the peak power of the power converter is to increase the capacitance or the inductance. However, the increase of the capacitance has the drawback that also the losses increase in the power converter and that the components in the power converter have to be dimensioned to be able to handle these higher losses. The increase of the inductance has the drawback that the transformer becomes larger and more costly.

### SUMMARY OF THE INVENTION

It is an object of the invention to provide a power converter which is able to supply a large peak power without requiring over-dimensioned components.

A first aspect of the invention provides a power converter as claimed in claim 1. A second aspect of the invention provides an apparatus comprising a circuit operating different power modes and the power converter, as claimed in claim 10. A third aspect of the invention provides a method of controlling a power converter as claimed in claim 11. Advantageous embodiments are defined in the dependent claims.

A power converter in accordance with the first aspect of the invention comprises a series arrangement of a first main current path of a first controllable switch and a second main current path of a second controllable switch. A DC-input voltage is supplied across the series arrangement. A series arrangement of an inductance and a capacitance is arranged in parallel with the second main current path. An output node which supplies an output voltage of the power converter is coupled to the inductance. The inductance may be a coil represented by a single inductor, or the inductance of a transformer seen at its primary side. The inductance of a transformer seen at its primary side may be represented by a series arrangement of a magnetizing inductor and a leakage inductor. If a transformer is used, the output node is coupled to a secondary winding of the transformer. The inductance of the coil or transformer and capacitance of the capacitor form a resonant circuit.

A controller controls the first and the second controllable switch with a variable repetition frequency to stabilize the output voltage of the power converter. The controller controls the capacitance or the inductance in dependence on a required peak output power of the power converter. The output power may be sensed with a current sensor at the output, but alternatively, other signals may be used which represent the output power as will be elucidated with respect to relevant dependent claims. Preferably, the power converter is an LLC converter.

The capacitance value of the capacitor, and/or the inductance value of an inductor, is selected to fit the actual peak power to be supplied. Thus, the dimensioning of the power converter is automatically changed to meet the required peak current dependent on the output power to be supplied. Because the peak current has to be supplied only during short periods in time, the dimensioning of the components with respect to their thermal properties is determined by the average power to be supplied. In contrast, in the prior art LLC power converter, the capacitance and the inductance have a fixed value which is selected such that the highest peak power can be supplied. Thus, although during a large period of time the power supplied is much lower than the peak power, the switching losses due to the high capacitance value of the capacitor are continuously present. Consequently, the efficiency of the power converter is not optimal and the components have to be over-dimensioned to be able to handle these switching losses.

It has to be noted that U.S. Pat. No. 6,621,718 discloses a power converter with an oscillator operating with a fixed frequency and a resonance circuit coupled to the oscillator. This power converter stabilizes its output voltage by controlling the resonance of the resonance circuit and not by varying the operating frequency, and thus operates completely different than the present invention.

In an embodiment as claimed in claim 2, the capacitance is either a parallel arrangement of a first and a second capacitor or a series arrangement of a first and a second capacitor. The controller varies the capacitance by controlling a switch which connects the second capacitor in parallel with the first capacitor, or which short-circuits the second capacitor if arranged in series with the first capacitor. But, alternatively a component with a variable capacitance may be used. The inductance may be changed in a similar manner.

In an embodiment as claimed in claim 4, the inductor which is arranged in series with the capacitor comprises or is a primary winding of a transformer. The load is coupled to a secondary winding of the transformer.

In an embodiment as claimed in claim 5, the controller receives a command indicating a power mode of the load. The capacitance or inductance is increased if the power mode indicates a power consumption of the load which is higher than a predetermined level. In such an application the power mode of the load is known.

In an embodiment as claimed in claim 6, the load is a power consuming circuit or apparatus which has a first power mode being a standby mode and a second mode being a normal operating mode. The user may switch the circuit or apparatus between the normal mode and the standby mode. Dependent on the user choice, the controller controls the capacitance or inductance such that it has a lower value during the low-power standby mode than in the high power normal operating mode. For example, an apparatus with a standby mode may be a television set which has a low power standby mode and an operational mode. The switching between the high and the low power mode may be controlled by other external signals. For example in a mobile phone which communicates with a base station, the output power of the mobile phone may be set by the base station.

In an embodiment as claimed in claim 7, the controller has an input to receive the DC-input voltage to increase the capacitance or inductance if the DC-input voltage drops below a predetermined level. At a high DC-input voltage level, the power converter is able to supply a high peak output power. If the DC-input voltage drops, also the maximum peak output power decreases. Below a particular value of the DC-input voltage the capacitance or inductance may be enlarged to increase the peak power which can be supplied by the power converter.

In an embodiment as claimed in claim 8, the controller increases the capacitance or the inductance if the repetition frequency drops below a predetermined frequency. Consequently, the resonance frequency decreases and a higher peak output power is possible.

In an embodiment as claimed in claim 9, the controller comprises a frequency limiter which limits the repetition frequency to a predetermined minimal value. An error amplifier receives the output voltage and a reference level to determine whether the output voltage crosses the reference level. A clipping detector receives an output signal of the error amplifier to detect whether this output signal is clipping. The controller increases the capacitance or inductance if the clipping detector detects a clipped output signal. Consequently, if the switching frequency of the power converter reaches the minimal value, the capacitance or inductance is increased to lower the resonance frequency and the power converter is able to supply the higher peak power.

The minimal repetition frequency is equal to or somewhat higher than the actual resonance frequency to prevent the power converter to enter the so called capacitive mode. At the instant the power converter supplies its maximum peak power, the repetition frequency is equal to the minimal repetition frequency. Now, the error amplifier clips, this clipping can be easily detected and be used as a trigger to increase the capacitance or inductance.

These and other aspects of the invention are apparent from and will be elucidated with reference to the embodiments described hereinafter.

### BRIEF DESCRIPTION OF THE DRAWINGS

In the drawings:

FIG. 1 shows a schematic block diagram of an embodiment of an LLC converter in accordance with the invention,

FIG. 2 shows a circuit diagram of an alternative embodiment for varying the resonance capacitance of the LLC converter,

FIG. 3 shows a schematic circuit diagram of a circuit for varying the resonance capacitance in response to the level of the DC-input voltage of the converter,

FIG. 4 shows a block diagram for varying the resonance capacitance dependent on the repetition frequency of the converter,

FIG. 5 shows a repetition frequency range to elucidate the operation of the circuit shown in FIG. 4,

FIG. 6 shows a block diagram for varying the resonance capacitance dependent on the clipping of the error amplifier, and

FIG. 7 shows a repetition frequency range to elucidate the operation of the circuit shown in FIG. 6.

It should be noted that items which have the same reference numbers in different Figures, have the same structural features and the same functions, or are the same signals. Where the function and/or structure of such an item has been explained, there is no necessity for repeated explanation thereof in the detailed description.

### DETAILED DESCRIPTION

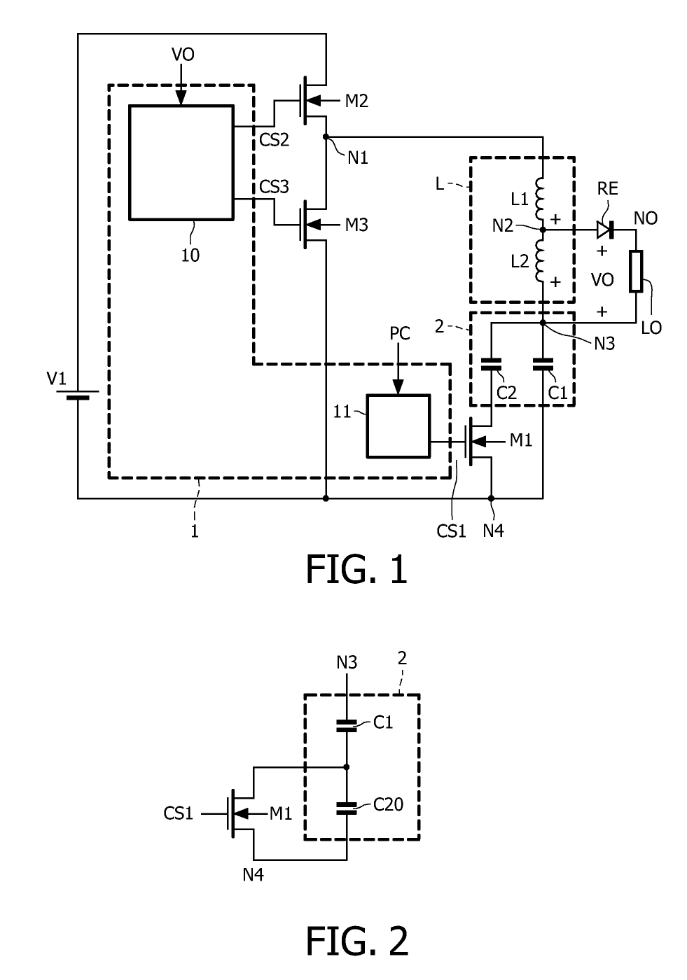

FIG. 1 shows a schematic block diagram of an embodiment of an LLC converter in accordance with the invention. The abbreviation LLC in the LLC converter stands for inductor, inductor, and capacitor. As is shown in FIG. 1, the LLC part of the LLC converter is formed by the series arrangement of the inductors L1 and L2, and the capacitor C1. The inductor L1 represents the leakage inductance and the inductor L2 represents the magnetizing inductance of a transformer. The load LO is coupled in parallel with the inductor L2 via an optional rectifier circuit RE. If a coil is used instead of the transformer, the inductance L1 is not present. The rectifier circuit RE may comprise a single diode, a full bridge, or any other suitable rectifying element or circuit. The output voltage of the LLC converter across the load is denoted by VO.

The inductor L1 is arranged between the nodes N1 and N2. The inductor L2 is arranged between the nodes N2 and N3. The capacitor C1 is arranged between the nodes N3 and N4. The LLC converter further comprises two main switches M2 and M3 of which the main current paths are arranged in series to receive a DC-input voltage V1. The junction of the two main current paths is the node N1, and the main switch M3 is arranged between the nodes N1 and N4. A control circuit 10 has two outputs for supplying switch signals CS2 and CS3 to the two main switches M2 and M3, respectively. The control circuit 10 alternatively switches the main switches M2 and M3 on and off. The correct switching of the main switches M2 and M3 is well known in the art. The inductors L1, L2 and the capacitor C1 form a resonant circuit which resonates at a particular resonance frequency fr1 which is determined by the inductance formed by the inductors L1 and L2 and the capacitance of the capacitor C1.

The control circuit 10 receives the output voltage VO, which usually is tapped-in to obtain an appropriate level, to control the repetition frequency fr of the main switches M2 and M3 to stabilize the output voltage VO, as is also well known in the art. Usually, the repetition frequency fr of the LLC converter is selected to be higher than the resonance frequency fr1 to keep the converter in its inductive mode and to prevent it to change to the capacitive mode. If the LLC converter supplies its maximum power, the repetition frequency fr is, or is almost identical to the resonance frequency fr1. If the output power decreases, the control circuit increases the repetition frequency fr to lower the quality factor of the series resonant circuit formed by the inductance and the capacitance thereby preventing the output voltage VO to increase.

In accordance with an embodiment of the present invention, the LLC converter further comprises a switch circuit M1 which varies the resonance capacitance of the LLC converter to vary the resonance frequency fr1. In the embodiment shown in FIG. 1, the switch circuit M1 comprises a switch M1, and the resonance capacitance comprises the capacitor C1 and a capacitor C2. The switch M1 is arranged in series with the capacitor M2, and this series arrangement is arranged in parallel with the capacitor C1. The total capacitance formed by the capacitors C1 and C2 determines the resonance frequency. A controller 11 supplies a control signal CS1 to control the switch M1. If the switch M1 is open, the resonance capacitance is C1 and the resonance frequency is fr1. If the switch M1 is closed, the resonance capacitance is increased by connecting the capacitor C2 in parallel with the capacitor C1. The resulting resonance frequency fr2 is lower than the resonance frequency fr1.

In the embodiment shown in FIG. 1, the switching of the switch M1 is performed in response to a command PC. The controller 11 may receive the command PC to convert it in the switch signal CS1 suitable for the switch M1. If the command PC has the suitable levels, it may be supplied to the control input of the switch M1 directly. The command PC may be standby command which indicates that the load LO has to enter a low power mode in which the power consumed by the load LO drops with respect to the normal operating mode. This power consumption drop may be considerable. In the prior art, the resonance capacitance 2 has a single value which is selected to be able to supply the maximum requested peak power to the load during the normal operating mode. The same resonance capacitance 2 is present during the standby mode. Consequently, due to the high capacitance value, the switching losses in standby are relatively high. This is an important drawback as consumers are more and more aware of the costs caused by a high power consumption in the standby mode of their electronic equipment.

However, due to the relatively low peak power which has to be supplied during the standby mode, this resonance capacitance 2 is allowed to have a smaller value during the standby mode than during the normal operating mode.

In accordance with the present invention, the value of the capacitor C1 is selected to be able to supply the peak output power during the standby mode, and the value of the capacitor C2 is selected such that the parallel arrangement of the capacitors C1 and C2 is sufficiently high to be able to supply the peak power during normal operating mode. Thus, by disconnecting the capacitor C2 during the standby mode, the switching losses are relatively low during the standby mode, and by connecting the capacitor C2 in parallel with the capacitor C1 during the normal operating mode, the required high peak current can be delivered during normal operating mode.

This variation of the resonance capacitance 2 to decrease the losses in the LLC converter at a low peak power can be used in all applications having different power consuming modes. For example, in mobile communication devices which have a variable transmission power. In this kind of applications, the efficiency of the power converter is very important to optimize the time the battery can be used before it has to be recharged.

The controllers 10 and 11 are together also referred to as the controller 1. In a practical implementation, the controllers 10 and 11 may be present in the same integrated circuit.

FIG. 2 shows a circuit diagram of an alternative embodiment for varying the resonance capacitance 2 of the LLC converter. Now, the resonance capacitor 2 comprises a series arrangement of the capacitors C1 and C2. The switch M1 is arranged in parallel with the capacitor C2. If the switch M1 is closed, the resonance capacitance 2 is determined by the value of the capacitor C1, if the switch M1 is open, the resonance capacitance 2 is determined by the capacitance of the series arrangement of the capacitors C1 and C2.

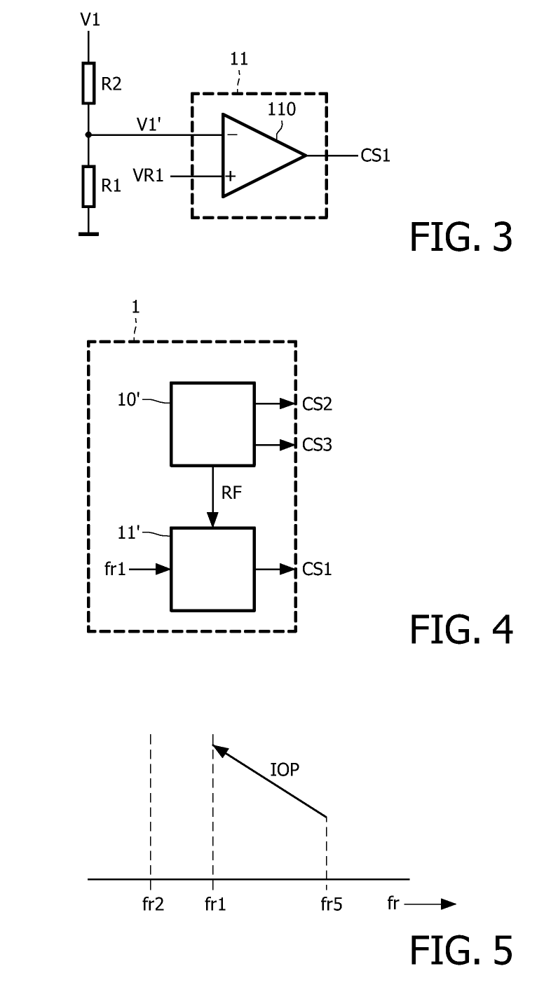

FIG. 3 shows a schematic circuit diagram of a circuit for varying the resonance capacitance 2 in response to the level of the DC-input voltage of the power converter. The controller 11 now comprises a comparator 110 with a non-inverting input which receives a reference level VR1, an inverting input which receives a tapped-in input voltage V1′, and an output which supplies the control signal CS1. The tapped-in input voltage V1′ is obtained from the DC-input voltage V1 with the resistor divider R1 and R2. As long as the tapped-in input voltage V1′ is higher than the reference level VR1, the switching signal CS1 has a low level, and the switch M1 is open. In the topology shown in FIG. 1, the resonance capacitance 2 is determined by the capacitor C1, and thus is relatively low. If the tapped-in input voltage V1′ is lower than the reference level VR1, the switching signal CS1 has a high level, and the switch M1 is closed. In the topology shown in FIG. 1, the resonance capacitance 2 is determined by the parallel arrangement of the capacitors C1 and C2, and thus is relatively high. Consequently, if the DC-input voltage V1 has a high level and the LLC converter is able to supply a high peak output power, a smaller capacitance 2 may be used than at low levels of the DC-input voltage V1. Again, the efficiency of the power converter is optimized by selecting a capacitance 2 fitting the peak power to be supplied.

Because it is known in a particular implementation of the power converter what the relation is between the DC-input voltage level and the peak power which can be supplied at a particular level of the DC-input voltage, it is possible to control the capacitance 2 in dependence on the peak power to be supplied by using the level of the DC-input voltage.

FIG. 4 shows a block diagram for varying the capacitance dependent on the repetition frequency of the converter. The converter 1 comprises the frequency determining circuit 10′ which generates the switch signals CS2 and CS3 with the repetition frequency fr. Usually, the repetition frequency fr is controlled to stabilize the output voltage VO. The frequency determining circuit 10′ generates a frequency signal RF which is an indication for the value of the variable repetition frequency fr. The switch control circuit 11′ receives the frequency signal RF to supply the switching signal CS1 for increasing the capacitance 2 if the repetition frequency fr drops below the resonance frequency fr1 determined by the inductances L1, L2 and the capacitor C1. This is elucidated in more detail with respect to FIG. 5.

FIG. 5 shows a repetition frequency range to elucidate the operation of the circuit shown in FIG. 4. The horizontal axis depicts the repetition frequency fr of the power converter. The vertical dashed lines indicate the resonance frequencies fr1 and fr2. The arrow indicated by IOP indicates the direction of change of the repetition frequency fr of the power converter if the peak output power increases.

In this example, with respect to the topology shown in FIG. 1, it is assumed that in the starting situation, the switch M1 is open, the peak power IOP is lower than a particular value, and the repetition frequency fr of the power converter is frs and thus higher than the resonance frequency fr1. Now, the peak power IOP starts increasing which is schematically indicated by the arrow. The frequency determining circuit 10′ decreases the repetition frequency fr towards the resonance frequency fr1 to stabilize the output voltage VO. The peak power IOP further increases until the resonance frequency fr1 is reached. Now, the switch control circuit 11′, which compares the actual repetition frequency fr as indicated by the signal FR with the resonance frequency fr1, closes the switch M1 and the capacitance 2 is enlarged. Consequently the resonance frequency decreases to the value fr2. Consequently, the peak output power IOP may further rise until the resonance frequency fr2 is reached. If the peak power decreases, the repetition frequency fr increases. As soon as the switch control circuit 11′ detects that the repetition frequency fr increases above the resonance frequency fr1, the switch M1 is opened. It is possible to implement a hysteretic behavior. For example, the switch M1 is opened when the repetition frequency fr becomes higher than the resonance frequency fr1 plus a particular delta frequency.

Again, the value of the capacitance 2 is selected to lower the switching losses at relatively low peak output powers by decreasing the capacitance value, and still enabling a high peak power if requested by enlarging the capacitance 2 if required.

The signal RF may already indicate whether the repetition frequency is above or below a particular frequency. Now, the switch circuit 11′ need not be aware of the particular frequency.

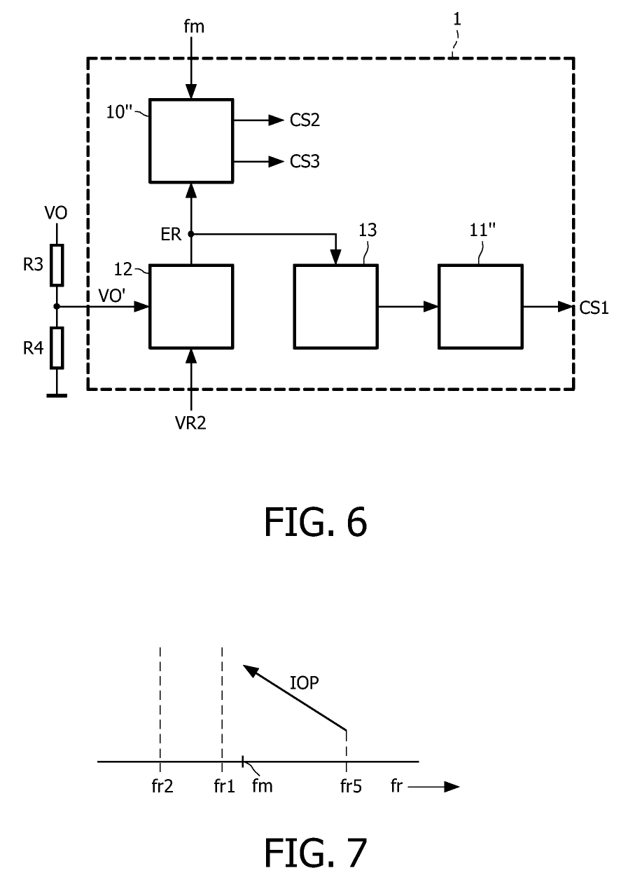

FIG. 6 shows a block diagram for varying the resonance capacitance dependent on the clipping of the error amplifier. The controller 1 comprises a controller 10″, an error amplifier 12, a clipping detector 13, and a switch control circuit 11″.

The error amplifier 12 receives a tapped-in output voltage VO′ obtained with the resistor divider R3, R4. The error amplifier 12 compares the tapped-in output voltage VO′ with a predetermined level VR2 and supplies an error signal ER indicative of the difference between the tapped-in output voltage VO′ and the predetermined level VR2.

The controller 10″ receives the error signal ER and supplies the switch signals CS2 and CS3 with the repetition frequency fr which is controlled to stabilize the output voltage VO. Further, the controller 10″ is aware of a predetermined minimal value fm for limiting the repetition frequency fr to this predetermined minimal value fm.

The clipping detector 13 receives the error signal ER to detect a clipping of the error signal ER. The clipping of the error signal ER occurs if the peak output power increases to a level that output voltage VO decrease can not anymore compensated for because the repetition frequency fr has reached the minimal fm. Consequently, the relatively large difference between the tapped-in output voltage VO′ and the predetermined level VR2 causes the error amplifier 12 to clip to one of the extremes of its voltage or current range.

The switch control circuit 11″ changes the switch signal CS1 to increase the capacitance 2 if the clipping detector 13 has detected the clipping of the error signal ER. Consequently, the resonance frequency drops, the repetition frequency can be decreased further and the clipping does not anymore occur. The minimal value fm should now be changed to fit the lower resonance frequency.

Often, it is also possible to set the maximum value of the repetition frequency. By also decreasing this maximum value when the capacitance 2 is increased, the error amplifier 12 will clip again when the peak power decreases and the maximum value of the repetition frequency is reached. This clipping can be used as the trigger to decrease the capacitance 2, and to increase both the minimal value and the maximum value.

FIG. 7 shows a repetition frequency range to elucidate the operation of the circuit shown in FIG. 6. The horizontal axis depicts the repetition frequency fr of the power converter. The vertical dashed lines indicate the resonance frequencies fr1 and fr2, and the minimum value fm. The arrow indicated by IOP indicates the direction of change of the repetition frequency fr of the power converter if the peak output power IOP increases.

In this example, with respect to the topology shown in FIG. 1, it is assumed that in the starting situation, the switch M1 is open, the peak power IOP is lower than a particular value, and the repetition frequency fr of the power converter is frs and thus higher than the resonance frequency fr. Now, the peak power IOP starts increasing which is schematically indicated by the arrow. The increasing peak power IOP causes the output voltage VO to drop. This drop causes the error amplifier 12 to increase the error signal ER. The controller 10″ decreases the repetition frequency fr in response to the error signal ER as long as the repetition frequency is higher than the minimal value fm. The decrease of the repetition frequency fr towards the resonance frequency fr1 increases the power supplied to the load and the output voltage VO starts increasing towards the desired level determined by the predetermined value or level VR2. If however, the power required by the load LO is so large that the minimal value fm of the repetition frequency fr is reached, the controller 10″ is not able to further decrease the repetition frequency. Consequently, the error signal ER will grow until it clips against a power supply voltage or current. This clipping is detected by the clipping detector 13 and is used as the trigger to close the switch M1. The capacitance 2 increases, the resonance frequency drops to fr2 and the clipping does not anymore occur.

Again, the value of the capacitance 2 is selected to lower the switching losses at relatively low peak output powers by decreasing the capacitance value, and still enabling a high peak power if requested by enlarging the capacitance 2 if required.

It should be noted that the above-mentioned embodiments illustrate rather than limit the invention, and that those skilled in the art will be able to design many alternative embodiments without departing from the scope of the appended claims.

For example, the embodiments show switching of the capacitor C2 to change the value of the capacitance 2. However this capacitance may be change in any other manner, for example by using components of which the capacitance can be varied for example by the voltage across them. Although the embodiments show an LLC converter, it will be clear to the skilled person that the present invention may also be applied on other resonant power converters in which the resonance frequency is determined by a capacitance and an inductance, and in which the output voltage is stabilized by controlling the repetition frequency with which the main switches are switched. Instead of varying the capacitance, also the inductance may be varied.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A power converter comprising
a series arrangement of a first main current path of a first controllable switch (M2) and a second main current path of a second controllable switch (M3), the series arrangement being arranged for receiving a DC-input voltage (V1),
a series arrangement of an inductance (L) and a capacitance (2) being arranged in parallel with the second main current path, wherein the inductance (L) and capacitance (2) determine a resonance frequency (fr1, fr2),
an output node (NO) coupled to the inductance (L) for supplying an output voltage (VO) of the power converter,
a means (M1) for varying the capacitance (2) or the inductance (L), and
a controller (1) for controlling the first controllable switch (M2) and the second controllable switch (M3) with a variable repetition frequency (fr) to stabilize the output voltage (VO), and for controlling the means (M1) for varying to vary the capacitance (2) or the inductance (L) in dependence on a required peak output power of the power converter.

2. A power converter as claimed in claim 1, wherein:
the capacitance (2) comprises a first capacitor (C1) and a second capacitor (C2; C20),
the controller (1) is constructed for supplying a switching signal (CS1), and
the means (M1) for varying comprise a switch (M1) having a control input for receiving the switching signal (CS1) for selectively connecting the second capacitor (C2) in parallel with the first capacitor (C1), or for selectively short circuiting the second capacitor (C20) if arranged in series with the first capacitor (C1).

3. A power converter as claimed in claim 1, further comprising a rectifier (RE) coupled between the inductor (L1, L2) and the output node (NO) for supplying the output voltage (VO) being a DC-voltage to a load (LO).

4. A power converter as claimed in claim 1, wherein the inductance comprises a primary winding of a transformer, and wherein a load is coupled to a secondary winding of the transformer.

5. A power converter as claimed in claim 1, wherein the controller (1) is arranged for receiving a command (PC) indicating a power mode of a load (LO) being coupled to the output node (NO) to increase the capacitance (2) or the inductance (L) if the command (PC) indicates a power consumption of the load (LO) higher than a predetermined level.

6. A power converter as claimed in claim 5, wherein the load (LO) has a first power mode being a standby mode and a second mode being a normal operating mode, wherein the command (PC) is a standby command, and wherein the capacitance (2) or the inductance (L) has a lower value during the standby mode than during the normal mode.

7. A power converter as claimed in claim 1, wherein the controller (1) comprises a comparator (110) having a first input for receiving the DC-input voltage (V1), a second input for receiving a predetermined level (VR1) and an output for supplying a switching signal (CS1) to the means (M1) for varying to increase the capacitance (2) or the inductance (L) if the DC-input voltage (Vi) drops below the predetermined level (VR1).

8. A power converter as claimed in claim 1, wherein the controller (1) comprises:
a frequency determining circuit (10′) for generating a frequency signal (RF) indicating the variable repetition frequency (fr), and
a switch control circuit (11′) for receiving the frequency signal (RF) to supply the switching signal (CS1) for increasing the capacitance (2) or the inductance (L) if the repetition frequency (fr) drops below a predetermined frequency (fr1).

9. A power converter as claimed in claim 1, wherein the controller (1) comprises:
means (10″) for limiting the repetition frequency (fr) to a predetermined minimal value (fm), and
an error amplifier (12) for receiving a reference signal (VR2) and an input signal (VO′) being proportional to the output voltage (VO) to supply an error signal (ER) indicating a difference between the input signal (VO′) and the reference signal (VR2),
a clipping detector (13) for receiving the error signal (ER) to detect a clipping of the error signal (ER), and
a switch control circuit (11″) for increasing the capacitance (2) if the clipping detector (13) has detected the clipping of the error signal (ER).

10. An apparatus comprising a circuit (LO) operating in different power modes wherein the circuit (LO) consumes different powers, and the power converter as claimed in claim 1, wherein the circuit is coupled to the output node (NO).

11. A method of controlling a power converter comprising a series arrangement of a first main current path of a first controllable switch (M2) and a second main current path of a second controllable switch (M3), the series arrangement being arranged for receiving a DC-input voltage (V1), a series arrangement of an inductance (L) and a capacitance (2) being arranged in parallel with the second main current path, and an output node (NO) coupled to the inductance (L) for supplying an output voltage (VO) of the power converter, and wherein the method comprises controlling (1) the first controllable switch (M2) and the second controllable switch (M3) with a variable repetition frequency (fr) to stabilize the output voltage (VO), and varying (M1) the capacitance (2) or the inductance (L) in dependence on an required peak output power of the power converter.
